(19) United States
(12) Patent Application Publication
(10) Pub. No.: US 2023/0134928 A1
(43) Pub. Date: May 4, 2023

(54) ELECTRONIC ACTUATOR FOR WORKING FLUID FLOW CONTROL

(71) Applicant: TRANE INTERNATIONAL INC., Davidson, NC (US)

(72) Inventors: Lucas Duffy, La Crosse, WI (US); Steven J. Pitts, La Crescent, MN (US); Justin D. Piggush, La Crosse, WI (US)

(21) Appl. No.: 17/453,126

(22) Filed: Nov. 1, 2021

(51) Int. Cl. F25B 41/35

(52) U.S. Cl. CPC F25B 41/35

(57) ABSTRACT

An electronic actuator assembly operates an in-line valve. A valve seat of the in-line valve is surrounded by a plate. The plate can include one or more openings configured to allow fluid to pass through the plate. A perimeter of the plate outside of the openings can be configured to have ends of pipes joined on either side of the plate. The in-line valve can be operated by an electronic actuator. The electronic actuator can be powered by a supply line that enters the assembly through the plate. The electronic actuator assembly can be incorporated in to a fluid circuit to serve as an expander. The electronic actuator can be located in a housing to direct flow around the electronic actuator. The electronic actuator can be installed in place of an orifice plate of an existing fluid circuit of a heating, ventilation, air conditioning, or refrigeration (HVACR) system.

### FIELD

This disclosure is directed to electronic actuators for controlling flow of working fluid, particularly for use as expanders in fluid circuits in heating, ventilation, air conditioning, and refrigeration (HVACR) systems.

### BACKGROUND

Expanders in fluid circuits allow the expansion of a working fluid as part of the refrigeration cycle. Typical expanders include many fixed devices such as orifice plates, which do not offer controllability of the orifice size or other aspects of their function. Fixed expanders thus are not able to adapt to different flow levels or flow rates. Orifice plates can be installed in piping in fluid circuits.

### SUMMARY

This disclosure is directed to electronic actuators for controlling flow of working fluid, particularly for use as expanders in fluid circuits in heating, ventilation, air conditioning, and refrigeration (HVACR) systems.

By providing a controllable in-line valve using a plate with a relatively small thickness, width, or height to be disposed between ends of pipes, electronic actuators according to embodiments can provide simple installation or retrofitting options allowing the introduction of a controllable expander into a fluid circuit. Electronic actuators according to embodiments can be readily substituted in place of an orifice plate or other fixed expander. The use of these actuators over fixed expanders can in turn offer improvements to flow control and efficiency of the fluid circuit by allowing the expander to be controlled in response to various operating conditions.

In an embodiment, a fluid circuit includes a compressor, a first heat exchanger, a second heat exchanger, and an expander located along a pipe extending from the first heat exchanger to the second heat exchanger. The expander includes an actuator configured to modify a proportion of opening of the expander.

In an embodiment, the expander includes a valve seat providing a first orifice, a valve stem configured to obstruct the first orifice when in a first position and to allow flow through the first orifice when the valve stem is in a second position and a plate surrounding the valve seat, the plate including a second orifice. The actuator is configured to move the valve stem such that the valve stem can be moved between the first position and the second position, the actuator and the valve stem each located entirely within the pipe.

In an embodiment, the expander includes a fixed plate including a first aperture and a first rotating plate including a second aperture, and the actuator is configured to rotate the first rotating plate such that alignment of the first aperture with the second aperture is adjustable.

In an embodiment, the expander further includes a second rotating plate, the second rotating plate including a third aperture, and wherein the actuator is further configured to rotate the second rotating plate such that alignment of the third aperture with the first aperture and the second aperture is adjustable.

In an embodiment, the pipe includes a first pipe section joined to a first side of the expander and a second pipe section joined to a second side of the expander, the second side of the expander opposite the first side of the expander.

In an embodiment, the fluid circuit further includes a power connection located on an outer surface of the expander, the outer surface of the expander being outside the pipe, wherein the power connection is configured to allow a supply of power to the actuator.

In an embodiment, the fluid circuit further includes a housing configured to direct fluid flow around the actuator, the housing being located entirely within the pipe.

In an embodiment, the fluid circuit is configured to circulate a low pressure working fluid.

In an embodiment, a center of the actuator is offset from a center of the plate.

In an embodiment, heating, ventilation, air conditioning, and refrigeration (HVACR) system comprising the fluid circuit as described above.

In an embodiment, a method of retrofitting an existing heating, ventilation, air conditioning, and refrigeration (HVACR) system, includes removing an existing expander from a fluid circuit of the HVACR system and installing a controllable expander into the fluid circuit of the HVACR system, the controllable expander including an actuator configured to modify a proportion of opening of the expander.

In an embodiment, the controllable expander further includes a valve seat providing a first orifice, a valve stem configured to obstruct the first orifice when in a first position and to allow flow through the first orifice when in a second position, and a plate surrounding the valve seat, the plate including a second orifice. The actuator is configured to move the valve stem such that the valve stem can be moved between the first position and the second position, wherein a perimeter of the plate extends outwards beyond a perimeter of the actuator.

In an embodiment, the expander includes a fixed plate including a first aperture and a first rotating plate including a second aperture. In this embodiment, the actuator is configured to rotate the first rotating plate such that alignment of the first aperture with the second aperture is adjustable.

In an embodiment, the existing expander is an orifice plate.

In an embodiment, installing the controllable expander includes connecting a first pipe segment to a first side of the plate and connecting a second pipe segment to a second side of the plate, the second side opposite the first, such that the actuator is contained within one of the first pipe segment or the second pipe segment.

In an embodiment, an expander for use in a fluid circuit includes a valve seat providing a first orifice, a valve stem configured to obstruct the first orifice when in a first position and to allow flow through the first orifice when in a second position, a plate surrounding the valve seat, the plate including a second orifice, and an actuator configured to move the valve stem such that the valve stem can be moved between the first position and the second position. A perimeter of the plate extends outwards beyond a perimeter of the actuator.

In an embodiment, the plate includes a first pipe connection point on a first side of the plate and a second pipe connection point on a second side of the plate, the second side opposite the first.

In an embodiment, the expander further includes a power connection located on an outer surface at a perimeter of the plate.

In an embodiment, the expander further includes a housing configured to direct fluid flow around the actuator, the housing being located within a cylinder defined by the perimeter of the plate.

In an embodiment, a center of the valve seat is offset from a center of the plate.

### DRAWINGS

FIG. 1 shows a schematic of a fluid circuit according to an embodiment.

FIG. 2 shows a perspective view of an expander according to an embodiment.

FIG. 3 shows a sectional view of an expander according to an embodiment.

FIG. 4 shows a flowchart of a method for retrofitting a heating, ventilation, air conditioning, and refrigeration (HVACR) system.

FIG. 5 shows a perspective view of an expander according to an embodiment.

FIG. 6 shows a chiller according to an embodiment.

FIG. 7 shows a front view of an expander according to an embodiment.

FIG. 8 shows a side view of the expander of FIG. 7.

### DETAILED DESCRIPTION

This disclosure is directed to electronic actuators for controlling flow of working fluid, particularly for use as expanders in fluid circuits in heating, ventilation, air conditioning, and refrigeration (HVACR) systems.

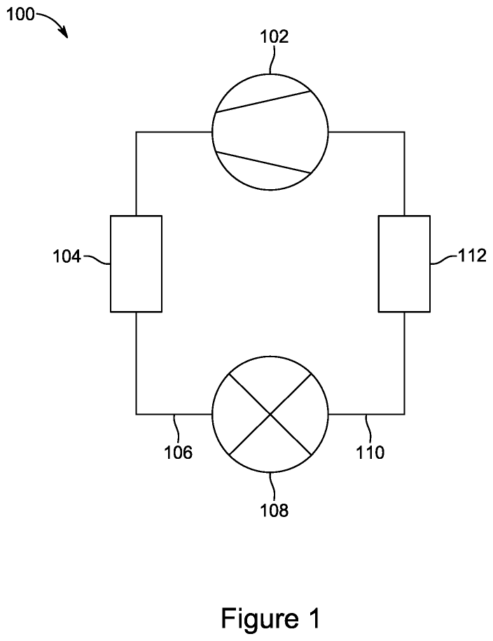

FIG. 1 shows a schematic of a fluid circuit according to an embodiment. Fluid circuit 100 includes compressor 102, first heat exchanger 104, first pipe section 106, expander 108, second pipe section 110, and second heat exchanger 112.

Fluid circuit 100 is configured to circulate a working fluid. The working fluid can be any suitable working fluid for use in a fluid circuit, such as for example a refrigerant. In an embodiment, the working fluid can be a low pressure working fluid. The low pressure working fluid can be a refrigerant capable of being used in a system where the working fluid is at a pressure less than atmospheric pressure during at least a portion of the refrigeration cycle. Non-limiting examples of low pressure working fluid include R11, R123, R514a and R1233zd(E), or the like.

Compressor 102 is a compressor configured to compress the working fluid that is circulated in fluid circuit 100. Compressor 102 can be any suitable compressor, such as, as non-limiting examples, a screw compressor, a centrifugal compressor such as a multi-stage centrifugal compressor, a scroll compressor, or the like. Working fluid compressed by the compressor 102 then moves to first heat exchanger 104, which serves as a condenser where the working fluid rejects heat. The rejection of heat can be to, for example, a source fluid, an ambient environment, or any other suitable acceptor of heat from the working fluid. The working fluid from first heat exchanger 104 then passes to expander 108. The working fluid passes from first heat exchanger 104 to expander 108 by way of a flow path including first pipe section 106. First pipe section 106 is a segment of pipe connected to expander 108 such that the expander 108 can receive working fluid.

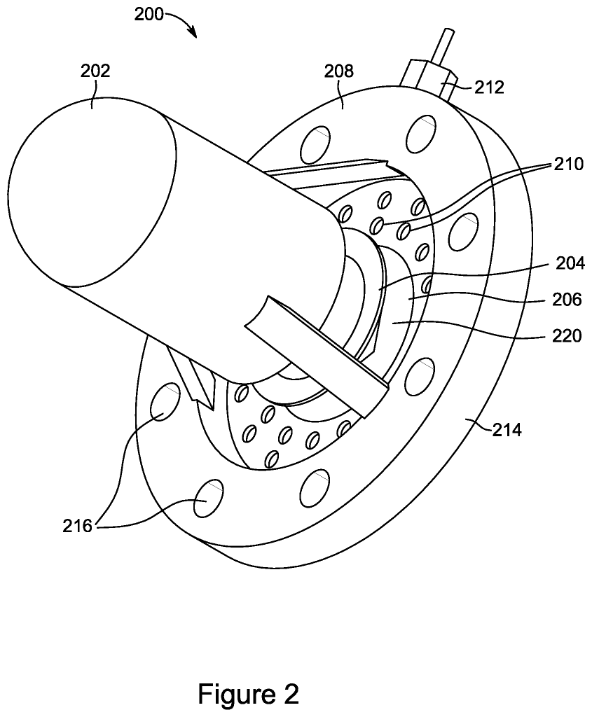

Expander 108 is configured to expand the working fluid received by way of first pipe section 106. The expander 108 can be a controllable expander configured to vary the orifice or orifices used in expansion of the working fluid. The expander 108 can be an in-line expander located within one or both of first pipe section 106 and second pipe section 110. Non-limiting examples of expander 108 are described below and shown in FIGS. 2-4. After passing through expander 108, working fluid passes through a fluid pathway including second pipe section 110 to second heat exchanger 112. Second heat exchanger 112 can serve as an evaporator where the working fluid absorbs heat, thus cooling a process fluid such as for example, water, air, glycol, or the like being conditioned to provide cooling.

While fluid circuit 100 is shown as including compressor 102, first heat exchanger 104, expander 108, and second heat exchanger 112, it is understood that fluid circuits according to embodiments can include further additional components including flow reversers or other flow controls, additional heat exchanger, economizers, and other such suitable components for inclusion in fluid circuits. The working fluid can then pass from second heat exchanger 112 to compressor 102 to continue circulation through fluid circuit 100.

FIG. 2 shows a perspective view of an expander according to an embodiment. Expander 200 includes a housing 202, a valve stem 204, a valve seat 206, and a plate 208. Plate 208 includes orifices 210. Power connection 212 is provided on a side surface 214 of plate 208. Plate 208 further includes fixation features 216. Optionally, expander 200 can further include a pressure relief line 218.

Expander 200 is a flow control configured to be used in a working fluid circuit to expand the working fluid. In an embodiment, the expander 200 can be included in a working fluid circuit between a first heat exchanger of the working fluid circuit and a second heat exchanger of the working fluid circuit, for example as described above and shown in FIG. 1. Expander 200 is configured to control a flow through the expander 200 such that the working fluid is expanded. Expander 200 can provide a flow, the flow including a flow component passing through the orifices 210 and a controllable component that can selectively be provided through the valve seat 206. In an embodiment, expander 200 can be used to control flow of a low pressure working fluid. The low pressure working fluid can be a refrigerant capable of being used in a system where the working fluid is at a pressure less than atmospheric pressure during at least a portion of the refrigeration cycle. Non-limiting examples of low pressure working fluid include R11, R123, R514a and R1233zd(E).

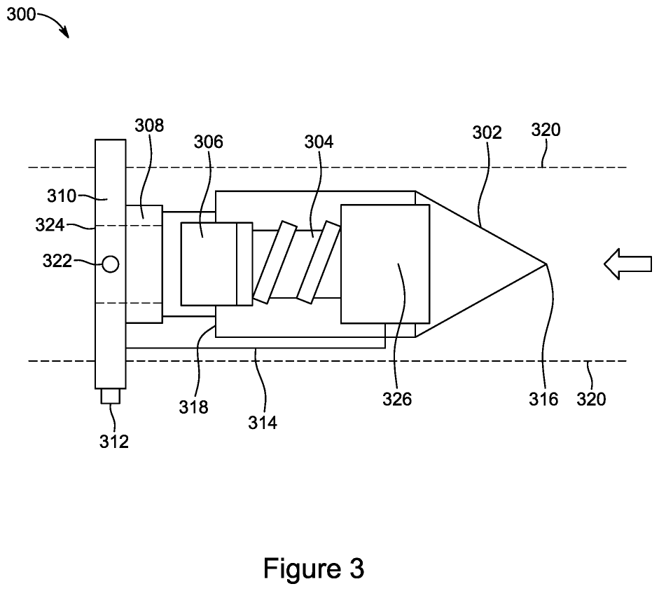

Housing 202 can surround an actuator (not shown, visible in FIG. 3) such that the housing 202 directs flow through a pipe into which expander 200 is installed around the actuator. Housing 202 can be shaped such that flow around it is less turbulent compared to flow over and around the actuator would be. Housing 202 can include tapered or curved portions to direct the flow around the actuator. Housing 202 can include a cavity configured to accommodate the actuator and at least part of valve stem 204. Housing 202 can have a closed end facing towards a direction of flow in the pipe into which expander 200 is installed. Housing 200 can have an open end from which valve stem 204 can protrude.

Valve stem 204 is a valve stem connected to an actuator (not shown, described below and shown in FIG. 3). The valve stem 204 is configured to be moved by the actuator between a first position where it interfaces with valve seat 206 to obstruct flow through the orifice 220 of the valve seat 206 and a second position where the orifice 220 of valve seat 206 is exposed. In an embodiment, the valve stem 204 has a major axis generally parallel to a flow of fluid through a pipe into which the expander 200 is installed. In an embodiment, the valve stem 204 is moved by the actuator in a direction generally perpendicular to a plane of the valve seat 206 and/or plate 208. In an embodiment, the valve stem 204 is moved by the actuator in a direction generally parallel to the pipe into which the expander 200 is installed. In an embodiment, the major axis of the valve stem 204 is generally parallel to the direction of movement of the valve stem 204 provided by the actuator.

Valve seat 206 includes an orifice 220 configured to allow flow of fluid through said orifice 220. Valve seat 206 is configured to receive valve stem 204, such that valve stem 204 can obstruct flow of fluid through the orifice 220 included in valve seat 206 when valve stem 204 is in the first position. Valve seat 206 is surrounded by plate 208. In an embodiment, valve seat 206 is centered with respect to the projection of plate 208. The orifice 220 through valve seat 206 can selectively allow flow through the valve seat 206 based on the position of valve stem 204, thus providing a controllable orifice in expander 200. Control of orifice 220 can allow changes to the proportion of opening of the expander 200 by affecting whether and how much of orifice 220 can permit flow, in addition to the one or more orifices 210 provided in plate 208.

Plate 208 extends outwards from the valve seat 206. In an embodiment, plate 208 extends outwards to at least a diameter of a pipe into which expander 200 is to be installed. In an embodiment, plate 208 has a thickness selected such that the thickness is similar to or the same as an existing orifice plate used in the pipe into which expander 200 is to be installed. Plate 208 includes one or more orifices 210. The one or more orifices 210 allow flow through plate 208. Flow through the one or more orifices 210 can combine with the flow through the orifice 220 included in valve seat 206 that is controlled by the position of valve stem 204. The one or more orifices 210 can provide a baseline orifice size for the expander 200, which can be supplemented by a variable orifice provided by valve seat 206 and valve stem 204. A thickness of plate 208 can be sufficient to accommodate power connection 212 on an outer surface of plate 208, where the power connection 212 can be presented outside a pipe that expander 200 is installed into.

Power connection 212 can be provided on plate 208. The position of power connection 212 on plate 208 can be located such that the power connection 212 is provided outside a pipe when expander 200 is installed into that pipe. In an embodiment, power connection 212 can be provided on a side surface 214 of the plate 208, the side surface 214 being an outer surface of the plate 208 between opposing first and second sides of the plate 208. In an embodiment, the side surface 214 can be at the outer perimeter of the plate 208. Power connection 212 provides a connection for a power supply, which can in turn supply power received at the power connection 212 to the actuator located within housing 202.

Fixation features 216 can be provided in or on plate 208. Fixation features 216 can be any suitable mechanical feature allowing one or more pipes to be joined to plate 208. In an embodiment, fixation features 216 are one or more holes configured to allow fasteners such as screws to be inserted through the plate 208. In this embodiment, the fasteners can be used to secure one or more pipes to the first and/or second sides of the plate 208. In an embodiment, when a pipe is secured to the plate 208 using the fixation features, the pipe can surround the housing 202, actuator, valve stem 204, and valve seat 206. Flow through a pipe connected to fixation features 216 can pass through expander 200 by way of the one or more orifices 210 provided in the plate 208 and can further selectively be allowed to pass through the orifice 220 provided in valve seat 206.

FIG. 3 shows a sectional view of an expander according to an embodiment. Expander 300 includes housing 302, actuator 304, valve stem 306, valve seat 308, and plate 310. Expander 300 includes a power connection 312 and a power line 314. Expander 300 can be installed into a pipe 320.

Housing 302 is a housing configured to direct flow of fluid around the actuator 304. Housing 302 is configured to accommodate at least a portion of actuator 304, and optionally further accommodate at least a portion of valve stem 306. Housing 302 can be closed at an end 316 facing a direction from which flow comes towards the expander 300. The housing 302 can have an open end 318 allowing a portion of actuator 304 and/or valve stem 306 to protrude outwards. The open end 318 can be opposite the closed end 316.

Actuator 304 is an actuator configured to move valve stem 306 along a direction of travel between at least a closed position and an open position. The direction of travel is such that valve stem 306 meets valve seat 308 when it is moved to the closed position. Then the valve stem 306 is in the closed position, flow through an orifice 324 provided in the valve seat 308 is obstructed. The direction of travel can be parallel or substantially parallel to a direction of fluid flow through the pipe 320 including expander 300. In an embodiment, the direction of travel can be generally perpendicular to the plate 310. The actuator 304 can be an electrically powered actuator, for example receiving power supplied to the power connection 312 by way of the power line 314. The actuator 304 can be any suitable actuator for controlling the position of valve stem 306. In an embodiment, the actuator 304 includes a stepper motor 326.

Valve stem 306 is a valve stem connected to actuator 304 such that the valve stem 306 can be moved by the actuator 304 between a first position where it interfaces with valve seat 308 to obstruct flow through the orifice 324 of the valve seat 308 and a second position where an orifice 324 in valve seat 308 is exposed. In an embodiment, the valve stem 306 has a major axis generally parallel to a flow of fluid through a pipe 320 into which the expander 300 is installed. In an embodiment, the valve stem 306 is moved by the actuator 304 in a direction perpendicular to a plane of the valve seat 308 and/or plate 310. In an embodiment, the valve stem 306 is moved by the actuator 304 in a direction generally parallel to the pipe 320 into which the expander 300 is installed. In an embodiment, the major axis of the valve stem 306 is generally parallel to the direction of movement of the valve stem 306 provided by the actuator 304.

Valve seat 308 includes an orifice 324 configured to allow flow of fluid through said orifice 324. Valve seat 308 is configured to receive valve stem 306, such that valve stem 306 can obstruct flow of fluid through the orifice 324 included in valve seat 308 when valve stem 306 is in the first position. The orifice 324 through valve seat 308 can selectively allow flow through the valve seat 308 based on the position of valve stem 306, thus providing a controllable orifice 324 in expander 300. The extent to which valve seat 308 and orifice 324 permit flow can effectively change a proportion of opening of the expander 300 by increasing or decreasing the area through which fluid can pass through expander 300 at orifice 324 in addition to other openings in plate 310.

Plate 310 extends outwards from the valve seat 308. In an embodiment, plate 310 extends outwards to at least a diameter of a pipe 320 into which expander 300 is to be installed. In an embodiment, plate 310 has a thickness selected such that the thickness is similar to or the same as an existing orifice 324 plate used in the pipe 320 into which expander 300 is to be installed. The thickness (width or height) in an embodiment refers to the longitudinal direction of the pipe 320 or existing orifice 324 plate or expander, for example along the direction of working fluid flow. While not visible in the section taken in FIG. 3, it is understood that the plate 310 can include orifice 324s such as the orifice 324s 210 described above and shown in FIG. 2. While not visible in the section taken in FIG. 3, it is understood that the plate 310 can include fixation features such as the orifice 324s fixation features 216 above and shown in FIG. 2.

Power connection 312 is provided on plate 310 such that it can be provided outside of the one or more pipes 320 to which expander 300 is connected. Power connection 312 is configured to allow connection to a power supply. In an embodiment, the power connection is provided on an outer surface of the plate 310. Power line 314 extends from plate 310 in a position that can be inside at least one pipe to which expander 300 is connected. Power line 314 extends to housing 302 or actuator 304 such that the power line 314 can convey power received at power connection 312 to the actuator 304. In an embodiment, power line 314 can further be configured to convey a control signal to actuator 304. The control signal can direct the actuator 304 to move valve stem 306 to a particular position, for example to obstruct or permit flow through the orifice 324 included in valve seat 308. One or more pressure taps 322 can be installed along the outer surface of the plate 310.

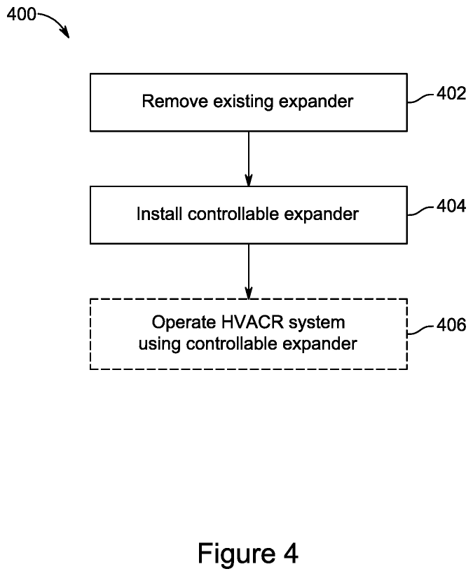

FIG. 4 shows a flowchart of a method for retrofitting a heating, ventilation, air conditioning, and refrigeration (HVACR) system. Method 400 includes removing an existing expander from a fluid circuit of the HVACR system 402. The method 400 also includes installing a controllable expander into the fluid circuit of the HVACR system 404. Optionally, method 400 can include operating the HVACR system 406, including expanding a working fluid by way of the controllable expander. Method 400 can be used to retrofit an HVACR system to add the functionality of the controllable expander, for example by replacing an existing fixed size expander with the controllable expander. In an embodiment, the HVACR system being retrofitted according to method 400 can be an HVACR system configured to circulate a low pressure working fluid. The low pressure working fluid can be a refrigerant capable of being used in a system where the working fluid is at a pressure less than atmospheric pressure during at least a portion of the refrigeration cycle. Non-limiting examples of low pressure working fluid include R11, R123, R514a, and R1233zd(E), and the like, and combinations thereof.

An existing expander is removed from a fluid circuit of the HVACR system at 402. The existing expander can be any suitable expander, such as an orifice, an expansion valve, or the like. In an embodiment, the existing expander removed at 402 is a fixed size expander. In an embodiment, the existing expander removed at 402 is an orifice plate. The orifice plate can be installed into the HVACR system along a pipe connecting a first heat exchanger and a second heat exchanger. In an embodiment, the orifice plate can be removed by removing pipe segments from either side of the orifice plate.

A controllable expander can be installed into the HVACR system at 404. The controllable expander can be a controllable expander such as expanders 200, 300, 400 shown in FIGS. 2-4. The controllable expander can be configured to be located within one or more pipes of the HVACR system extending from a first heat exchanger to a second heat exchanger. The controllable expander can be installed into the HVACR system by joining a first pipe section of the HVACR system to a first side of the controllable expander and joining a second pipe section of the HVACR system to a second side of the controllable expander. In an embodiment, a thickness of the plate is similar to or the same as a thickness of the expander removed at 402, such that the controllable expander can be installed in the same location the existing expander was removed from with minimal or no modification to the pipes of the HVACR system. In an embodiment, installation of the controllable expander 404 can further include connecting a power source to a power connection provided on the controllable valve.

In an embodiment, the HVACR system can be operated when including the controllable expander at 406. In operation, working fluid of the HVACR system can be expanded as it flows through the controllable expander. The controllable expander can be controlled to adjust flow suitable to the operation of the HVACR system by controlling a variable portion of flow by positioning the valve stem using the actuator. In an embodiment, an actuator of the controllable valve can be used to move the valve stem to obstruct flow or permit flow through the orifice provided in the valve seat to control the variable portion of the flow. There can also be fixed flow through one or more orifices provided on the plate that can provide a baseline flow when flow through the orifice in the valve seat is obstructed or supplementing the variable portion of the flow. The flow through the controllable expander can be controlled and varied throughout operation of the HVACR system.

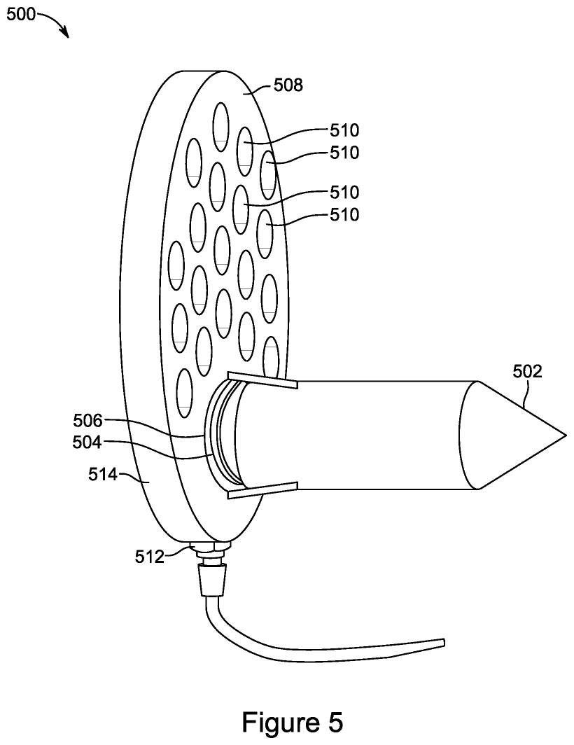

FIG. 5 shows a perspective view of an expander according to an embodiment. Expander 500 includes housing 502 surrounding an actuator (not shown), valve stem 504, valve seat 506, plate 508, and orifices 510 formed in the plate 508. Plate 508 further includes power connection 512 formed on an outer surface 514 of plate 508.

Expander 500 is a flow control configured to be used in a working fluid circuit to expand the working fluid. In an embodiment, the expander 500 can be included in a working fluid circuit between a first heat exchanger of the working fluid circuit and a second heat exchanger of the working fluid circuit, for example as described above and shown in FIG. 1. Expander 500 is configured to control a flow through the expander 500 such that the working fluid is expanded. Expander 500 can provide a flow including a component through the orifices 510 and a controllable component that can selectively be provided through the valve seat 506. In an embodiment, expander 500 can be used to control flow of a low pressure working fluid. The low pressure working fluid can be a refrigerant capable of being used in a system where the working fluid is at a pressure less than atmospheric pressure during at least a portion of the refrigeration cycle. Non-limiting examples of low pressure working fluid include R11, R123, R514a, and R1233zd(E), and the like, and combinations thereof.

Housing 502 is a housing configured to direct fluid flow around an actuator (not shown). The actuator can be an actuator as discussed above and shown in FIG. 3. Housing 502 can be shaped such that flow around it is less turbulent compared to flow over and around the actuator would be. Housing 502 can include tapered or curved portions to direct the flow around the actuator. Housing 502 can include a cavity configured to accommodate the actuator and at least part of valve stem 504. Housing 502 can have a closed end facing towards a direction of flow in the pipe into which expander 500 is installed. Housing 502 can have an open end from which valve stem 504 can protrude.

Valve stem 504 is a valve stem connected to the actuator. The valve stem 504 is configured to be moved by the actuator between a first position where it interfaces with valve seat 506 to obstruct flow through the orifice of the valve seat 506 and a second position where an orifice of valve seat 506 is exposed. In an embodiment, the valve stem 504 has a major axis generally parallel to a flow of fluid through a pipe into which the expander 500 is installed. In an embodiment, the valve stem 504 is moved by the actuator in a direction generally perpendicular to a plane of the valve seat 506 and/or plate 508. In an embodiment, the valve stem 504 is moved by the actuator in a direction generally parallel to the pipe into which the expander 500 is installed. In an embodiment, the major axis of the valve stem 504 is generally parallel to the direction of movement of the valve stem 204 provided by the actuator.

Valve seat 506 includes an orifice configured to allow flow of fluid through said orifice. Valve seat 506 is configured to receive valve stem 504, such that valve stem 504 can obstruct flow of fluid through the orifice included in valve seat 506 when valve stem 504 is in the first position. Valve seat 506 is surrounded by plate 508. The orifice through valve seat 506 can selectively allow flow through the valve seat 506 based on the position of valve stem 504, thus providing a controllable orifice in expander 500.

Plate 508 surrounds the valve seat 506. In an embodiment, plate 508 has a diameter at least equal to a diameter of a pipe into which expander 500 is to be installed. In an embodiment, plate 508 has a thickness selected such that the thickness is similar to or the same as an existing orifice plate used in the pipe into which expander 500 is to be installed. A thickness of plate 508 can be sufficient to accommodate power connection 512 on an outer surface 514 of plate 508 that can be presented outside a pipe that expander 500 is installed into.

Housing 502, valve stem 504, and valve seat 506 can be positioned offset from a center of plate 508 as shown in FIG. 5. Housing 502, valve stem 504, and valve seat 506 can be positioned such that a central axis of each or all of housing 502, valve stem 506 and valve seat 506 is not collinear with a central axis of the plate 508.

Orifices 510 are distributed on plate 508, apart from valve seat 506. Orifices 510 are openings through plate 508 each having a fixed size. Orifices 510 can provide a fixed flow of fluid through expander 500 that can optionally be supplemented by flow through valve seat 506 based on a position of valve stem 504. In an embodiment, the orifices 510 can each be holes drilled or otherwise machined in the plate 508. In an embodiment, one orifice 510 can be provided on plate 508. In an embodiment, a plurality of orifices 510 can be provided on plate 508. While orifices 510 are shown as circular in the embodiment shown in FIG. 5, it is understood that the orifices 510 can have any suitable shape or size based on the desired flow characteristics, manufacturability, and the like for expander 500.

Plate 508 further includes power connection 512 provided on an outer surface 514 of plate 508. Power connection 512 is a connection point for a power supply, which can in turn supply power received at the power connection 512 to the actuator located within housing 502. Power connection 512 can be presented outside of the pipe that expander 500 is installed into when the expander 500 is installed into said pipe.

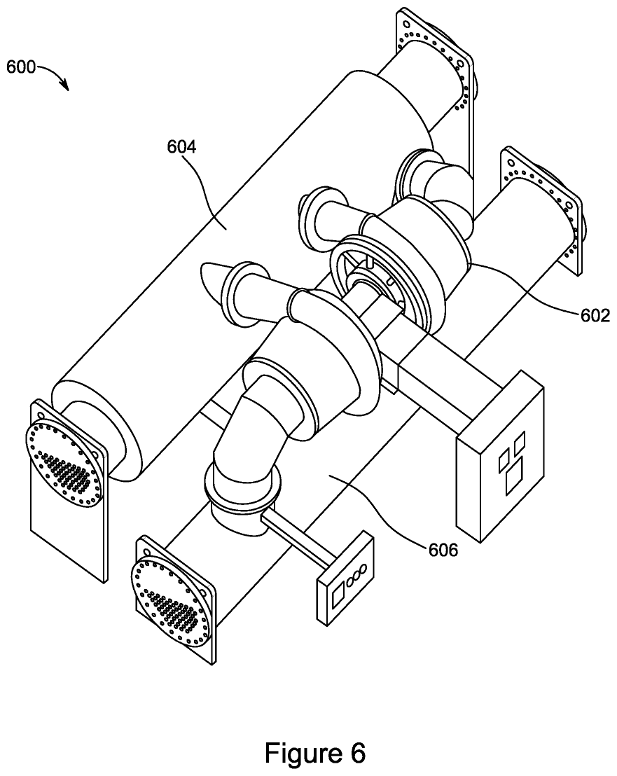

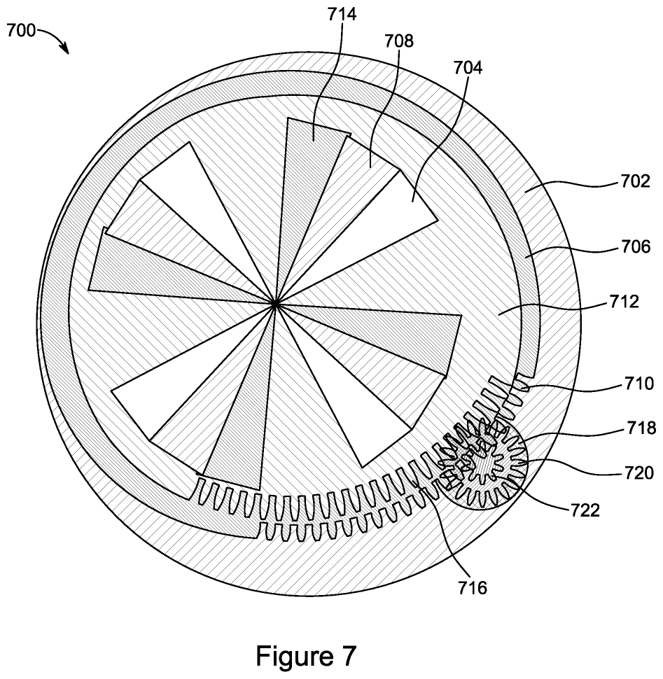

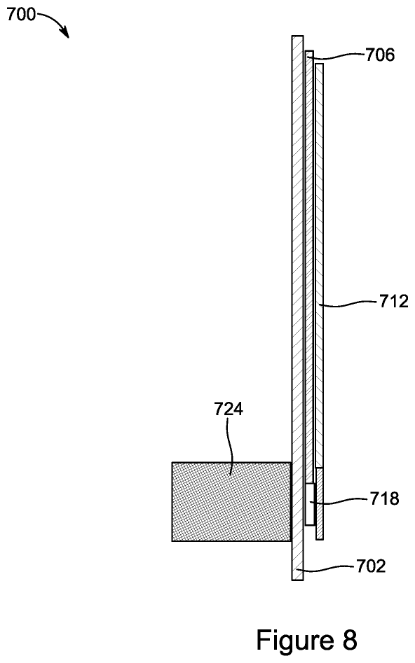

FIG. 6 shows a chiller according to an embodiment. Chiller 600 includes compressor 602, condenser 604, and evaporator 606, fluidly connected to one another to form a fluid circuit. The connections of the fluid circuit of chiller 600 can be according to the schematic shown in FIG. 1. An expander such as expander 108 as described above and shown in FIG. 1 can be included in the fluid connection between condenser 604 and evaporator 606. The expander can be an expander 200, expander 300, expander 500, or expander 700 as shown in FIG. 2, 3, or 5 and described above or as shown in FIGS. 7 and 8 and described below. The compressor 602 can be, as a non-limiting example, a centrifugal compressor as shown in FIG. 6. Compressor 602 can be a single- or multi-stage centrifugal compressor. It is understood that any suitable compressor such as, for example, scroll or screw compressors can be used as the compressor 602.

FIG. 7 shows a front view of an expander according to an embodiment. Expander 700 includes fixed plate 702 including first apertures 704. Expander 700 further includes first rotating plate 706 including second apertures 708 and first rotating plate teeth 710. Expander 700 also includes second rotating plate 712, including third apertures 714 and second rotating plate teeth 716. Expander 700 additionally includes drive gear 718, with drive gear 718 including first drive teeth 720 and second drive teeth 722.

Expander 700 is a variable-orifice expander configured to be installed into a fluid circuit such as fluid circuit 100 described above and shown in FIG. 1. In an embodiment, the expander 700 can be configured to replace an orifice plate used in an expander of a fluid circuit.

Fixed plate 702 is a plate configured to fill an entire fluid line into which it is installed. In an embodiment, fixed plate 702 can include an outer section including a plurality of fixation features, such as the fixation features 216 described above and shown in FIG. 2. In an embodiment, fixed plate 702 can have a thickness selected to correspond to a thickness of an orifice plate that is being replaced by the expander 700. Fixed plate 702 includes one or more apertures 704. The apertures 704 are openings extending through fixed plate 702. The alignment of the first apertures 704 with the second apertures 708 and the third apertures 714 can define the existence and/or size of orifices allowing flow of fluid through the expander 700.

First rotating plate 706 is a plate having a size smaller than fixed plate 702. First rotating plate 706 includes second apertures 708. Second apertures 708 are openings through the first rotating plate 706. That can be placed in or out of alignment with first apertures 704 and third apertures 714. The alignment of the first, second, and third apertures 704, 708, 714 can affect a size of orifices through the expander 700 based on the extent of the alignment. First rotating plate 706 can include first rotating plate teeth 710, configured to engage with drive gear 718 such that a rotational position of the first rotating plate 706 can be controlled by an actuator, such as actuator 724 as shown in FIG. 8 and described below.

Second rotating plate 712 is a plate having a smaller size than fixed plate 702. The second rotating plate can further have a smaller size than first rotating plate 706. In an embodiment, second rotating plate 712 can have an axis of rotation that is collinear with the axis of rotation of first rotating plate 706. Second rotating plate 712 includes third apertures 714, which are apertures through the second rotating plate 712 that can be placed in or out of alignment with first and second apertures 704, 708. In an embodiment, the third apertures 714 have the same size and general shape as at least one of the first apertures 704 or the second apertures 708. Second rotating plate 712 further includes second rotating plate teeth 716. The second rotating plate teeth 716 are configured to interface with teeth on drive gear 718 such that second rotating plate 712 can be rotated with respect to fixed plate 702.

Drive gear 718 is configured to control the rotational positions of first rotating plate 706 and second rotating plate 712 relative to the fixed plate 702. Drive gear 718 includes first drive teeth 720 and second drive teeth 722. First drive teeth 720 are configured to engage with the first rotating plate teeth 710 of first rotating plate 706, such that first rotating plate 706 can be rotated relative to fixed plate 702. Second drive teeth 722 are configured to engage second rotating plate teeth 716 such that second rotating plate 712 can be rotated relative to fixed plate 702. The size and spacing of the first drive teeth 720 and the second drive teeth 722 can be selected such that the relative rotation of first and second rotating plates 706, 712 with respect to fixed plate 702 affects the alignment of first apertures 704 with second apertures 708 and third apertures 714 such that a size of one or more orifices allowing fluid flow through the expander 700 can be controlled by operation of an actuator, such as actuator 724 shown in FIG. 8 and discussed below. The alignment of first apertures 704, second apertures 708, and third apertures 714 can adjust the proportion of opening of the expander, effectively changing the size of the opening permitting flow compared to the area covered by the expander. It is understood that the size, shape and number of each of the first apertures 704, second apertures, 708, and/or third apertures 714 can be any suitable configuration allowing the proportion of opening to be changed by rotation of one or more of first rotating plate 706 and/or second rotating plate 712 relative to the fixed plate 702. While first rotating plate 706 and second rotating plate 712 are shown in the embodiment shown in FIG. 7, it is understood that a single rotating plate or any number of additional rotating plates could be provided to control the proportion of opening of expander 700 by way of rotation of the rotating plate or plates.

FIG. 8 shows a side view of the expander of FIG. 7. In the side view of FIG. 8, the fixed plate 702, first rotating plate 706, second rotating plate 712, and drive gear 718 can be seen as discussed above and shown in FIG. 7. Additionally, actuator 724 can be seen on a side of fixed plate 702 opposite the first rotating plate 706, second rotating plate 712, and drive gear 718. In an embodiment, the actuator 724 can be positioned such that it is on a downstream side of expander 700. In an embodiment, actuator 724 is positioned away from the aperture defined by the fixed plate 702, first rotating plate 706 and second rotating plate 712 such that it is substantially out of the flow path for fluid passing through expander 700. Actuator 724 can be any suitable actuator for controlling the drive gear 718 to rotate and thus control the relative rotational positions of first rotating plate 706 and second rotating plate 712 with respect to fixed plate 702, such that an effective size of the apertures provided by expander 700 can be controlled. In an embodiment, actuator 724 is an electric motor, such as a stepper motor.

Aspects:

It is understood that any of aspects 1-10 can be combined with any of 11-15 or 16-20. It is understood that aspects 11-15 can be combined with any of aspects 16-20.

Aspect 1. A fluid circuit comprising:

a compressor;
a first heat exchanger;
a second heat exchanger; and
an expander located along a pipe extending from the first heat exchanger to the second heat exchanger,
wherein the expander includes an actuator configured to modify a proportion of opening of the expander.

Aspect 2. The fluid circuit according to aspect 1, wherein the expander further comprises:

a valve seat providing a first orifice;

a valve stem configured to obstruct the first orifice when in a first position and to allow flow through the first orifice when the valve stem is in a second position;

a plate surrounding the valve seat, the plate including a second orifice; and

wherein the actuator is configured to move the valve stem such that the valve stem can be moved between the first position and the second position, the actuator and the valve stem each located entirely within the pipe.

Aspect 3. The fluid circuit according to aspect 1, wherein the expander includes a fixed plate including a first aperture and a first rotating plate including a second aperture, and wherein the actuator is configured to rotate the first rotating plate such that alignment of the first aperture with the second aperture is adjustable.

Aspect 4. The fluid circuit according to aspect 3, wherein the expander further comprises a second rotating plate, the second rotating plate including a third aperture, and wherein the actuator is further configured to rotate the second rotating plate such that alignment of the third aperture with the first aperture and the second aperture is adjustable.

Aspect 5. The fluid circuit according to any of aspects 1-4, wherein the pipe includes a first pipe section joined to a first side of the expander and a second pipe section joined to a second side of the expander, the second side of the expander opposite the first side of the expander.

Aspect 6. The fluid circuit according to any of aspects 1-5, further comprising a power connection located on an outer surface of the expander, the outer surface of the expander being outside the pipe, wherein the power connection is configured to allow a supply of power to the actuator.

Aspect 7. The fluid circuit according to any of aspects 1-6, further comprising a housing configured to direct fluid flow around the actuator, the housing being located entirely within the pipe.

Aspect 8. The fluid circuit according to any of aspects 1-7, wherein the fluid circuit is configured to circulate a low pressure working fluid.

Aspect 9. The fluid circuit according to any of aspects 1-8, wherein a center of the actuator is offset from a center of the plate.

Aspect 10. A heating, ventilation, air conditioning, and refrigeration (HVACR) system comprising the fluid circuit according to any of aspects 1-9.

Aspect 11. A method of retrofitting an existing heating, ventilation, air conditioning, and refrigeration (HVACR) system, comprising:

removing an existing expander from a fluid circuit of the HVACR system; and

installing a controllable expander into the fluid circuit of the HVACR system, the controllable expander including an actuator configured to modify a proportion of opening of the expander.

Aspect 12. The method according to aspect 11, wherein the controllable expander further comprises:

a valve seat providing a first orifice;
a valve stem configured to obstruct the first orifice when in a first position and to allow flow through the first orifice when in a second position; and
a plate surrounding the valve seat, the plate including a second orifice;
wherein the actuator is configured to move the valve stem such that the valve stem can be moved between the first position and the second position, wherein a perimeter of the plate extends outwards beyond a perimeter of the actuator.

Aspect 13. The method according to aspect 11, wherein the expander includes a fixed plate including a first aperture and a first rotating plate including a second aperture, and wherein the actuator is configured to rotate the first rotating plate such that alignment of the first aperture with the second aperture is adjustable.

Aspect 14. The method according to any of aspects 11-13, wherein the existing expander is an orifice plate.

Aspect 15. The method according to any of aspects 11-14, wherein installing the controllable expander includes connecting a first pipe segment to a first side of the plate and connecting a second pipe segment to a second side of the plate, the second side opposite the first, such that the actuator is contained within one of the first pipe segment or the second pipe segment.

Aspect 16. An expander for use in a fluid circuit, comprising:

a valve seat providing a first orifice;
a valve stem configured to obstruct the first orifice when in a first position and to allow flow through the first orifice when in a second position;
a plate surrounding the valve seat, the plate including a second orifice; and
an actuator configured to move the valve stem such that the valve stem can be moved between the first position and the second position, wherein a perimeter of the plate extends outwards beyond a perimeter of the actuator.

Aspect 17. The expander according to aspect 16, wherein the plate includes a first pipe connection point on a first side of the plate and a second pipe connection point on a second side of the plate, the second side opposite the first.

Aspect 18. The expander according to any of aspects 16-17, further comprising a power connection located on an outer surface at a perimeter of the plate.

Aspect 19. The expander according to any of aspects 16-18, further comprising a housing configured to direct fluid flow around the actuator, the housing being located within a cylinder defined by the perimeter of the plate.

Aspect 20. The expander according to any of aspects 16-19, wherein a center of the valve seat is offset from a center of the plate.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A fluid circuit comprising:
a compressor;
a first heat exchanger;
a second heat exchanger; and
an expander located along a pipe extending from the first heat exchanger to the second heat exchanger,
wherein the expander includes an actuator configured to modify a proportion of opening of the expander.

2. The fluid circuit of claim 1, wherein the expander further comprises:
a valve seat providing a first orifice;
a valve stem configured to obstruct the first orifice when in a first position and to allow flow through the first orifice when the valve stem is in a second position;
a plate surrounding the valve seat, the plate including a second orifice; and
wherein the actuator is configured to move the valve stem such that the valve stem can be moved between the first position and the second position, the actuator and the valve stem each located entirely within the pipe.

3. The fluid circuit of claim 1, wherein the expander includes a fixed plate including a first aperture and a first rotating plate including a second aperture, and wherein the actuator is configured to rotate the first rotating plate such that alignment of the first aperture with the second aperture is adjustable.

4. The fluid circuit of claim 3, wherein the expander further comprises a second rotating plate, the second rotating plate including a third aperture, and wherein the actuator is further configured to rotate the second rotating plate such that alignment of the third aperture with the first aperture and the second aperture is adjustable.

5. The fluid circuit of claim 1, wherein the pipe includes a first pipe section joined to a first side of the expander and a second pipe section joined to a second side of the expander, the second side of the expander opposite the first side of the expander.

6. The fluid circuit of claim 1, further comprising a power connection located on an outer surface of the expander, the outer surface of the expander being outside the pipe, wherein the power connection is configured to allow a supply of power to the actuator.

7. The fluid circuit of claim 1, further comprising a housing configured to direct fluid flow around the actuator, the housing being located entirely within the pipe.

8. The fluid circuit of claim 1, wherein the fluid circuit is configured to circulate a low pressure working fluid.

9. The fluid circuit of claim 1, wherein a center of the actuator is offset from a center of the plate.

10. A heating, ventilation, air conditioning, and refrigeration (HVACR) system comprising the fluid circuit of claim 1.

11. A method of retrofitting an existing heating, ventilation, air conditioning, and refrigeration (HVACR) system, comprising:
removing an existing expander from a fluid circuit of the HVACR system; and
installing a controllable expander into the fluid circuit of the HVACR system, the controllable expander including an actuator configured to modify a proportion of opening of the expander.

12. The method of claim 11, wherein the controllable expander further comprises:
a valve seat providing a first orifice;
a valve stem configured to obstruct the first orifice when in a first position and to allow flow through the first orifice when in a second position; and
a plate surrounding the valve seat, the plate including a second orifice;
wherein the actuator is configured to move the valve stem such that the valve stem can be moved between the first position and the second position, wherein a perimeter of the plate extends outwards beyond a perimeter of the actuator.

13. The method of claim 11, wherein the expander includes a fixed plate including a first aperture and a first rotating plate including a second aperture, and wherein the actuator is configured to rotate the first rotating plate such that alignment of the first aperture with the second aperture is adjustable.

14. The method of claim 11, wherein the existing expander is an orifice plate.

15. The method of claim 11, wherein installing the controllable expander includes connecting a first pipe segment to a first side of the plate and connecting a second pipe segment to a second side of the plate, the second side opposite the first, such that the actuator is contained within one of the first pipe segment or the second pipe segment.

16. An expander for use in a fluid circuit, comprising:
a valve seat providing a first orifice;
a valve stem configured to obstruct the first orifice when in a first position and to allow flow through the first orifice when in a second position;
a plate surrounding the valve seat, the plate including a second orifice; and
an actuator configured to move the valve stem such that the valve stem can be moved between the first position and the second position, wherein a perimeter of the plate extends outwards beyond a perimeter of the actuator.

17. The expander of claim 16, wherein the plate includes a first pipe connection point on a first side of the plate and a second pipe connection point on a second side of the plate, the second side opposite the first.

18. The expander of claim 16, further comprising a power connection located on an outer surface at a perimeter of the plate.

19. The expander of claim 16, further comprising a housing configured to direct fluid flow around the actuator, the housing being located within a cylinder defined by the perimeter of the plate.

20. The expander of claim 16, wherein a center of the valve seat is offset from a center of the plate.
